(19) United States
(12) Patent Application Publication
(10) Pub. No.: US 2006/0099554 A1
(43) Pub. Date: May 11, 2006

(54) Smoking behaviour analyser

(76) Inventor: Barrie Edward Frost, Essex (GB)

Correspondence Address: MIDDLETON & REUTLINGER, 2500 BROWN & WILLIAMSON TOWER, LOUISVILLE, KY, 40202, US

(21) Appl. No.: 10/536,528

(22) PCT Filed: Nov. 26, 2003
(86) PCT No.: PCT/GB03/05153

§ 371 Date: Dec. 2, 2005

(30) Foreign Application Priority Data
Nov. 28, 2002 (GB) 0227715.0

(51) Int. Cl. G09B 19/00

(52) U.S. Cl. 434/236

(57) ABSTRACT

The invention relates to smoking behaviour analyser that allows a puff by puff real time analysis of a person's smoking behaviour whilst smoking. The device comprises smoking article mounting means for holding a smoking article in fluid-flow communication with fluid flow pressure drop detection means and smoke density detection means for detecting the optical density of the smoke; signal conversion means to convert signals obtained from the fluid flow pressure drop detection means and smoke density detection means into data; and data processing means operable to process data and provide a calculation of a delivery value of particulate phase smoke components from a smoking article. The data is displayed in graphical and/or numerical form.

This invention relates to the measurement and recording of the smoking behaviour of a consumer, particularly but not exclusively, cigarette smokers, and includes real-time smoke delivery measurement.

Various instruments have been produced which attempt to allow measurement of human smoking behaviour. For example, the Portable Smoking Topography Measurement Device by Plowshare Technologies is a device that records smoking behaviour of a subject in the field when smoking a smoking article using the device. The device records all smoking events for up to 4 weeks, which events can be subsequently downloaded (using associated software) to a computer. However, the recorded information (puff volume, duration, inter-puff interval, peak flow during puffs, time of peak flow, mean flow during puff, puff number) is limited in its usage. It does not, for example, include a real-time measurement of smoke delivery. The delivery of the individual cigarette smoked cannot be determined and can only be assumed from mathematical estimates based on the smoker's puff volumes and times or by duplication of the smoking session. Duplication involves smoking identical cigarettes on a special smoking machine that can reproduce the puffing behaviour of a smoker from the record of his smoking session. During duplication, the cigarettes smoked are attached to a conventional smoke-trapping device (such as a Cambridge Filter). The trapped smoke is analysed to assess the total smoke yield of the cigarette in the same way as the yield of a cigarette under standard machine smoking conditions is obtained. It is therefore necessary with the Plowshare device to re-smoke in a laboratory an identical cigarette (i.e. duplicate) in order to obtain the total cigarette yield of certain components, which is time-consuming. Only at this stage can an assessment be obtained of the smoke delivery obtained by the smoker. In addition, the smoking article used in duplication is not identical to that smoked initially, hence the smoke deliveries obtained by duplication may not be reliable.

As used herein, ‘delivery’ is the amount of a smoke component delivered to a smoker, whereas ‘yield’ is the amount of smoke component delivered to a smoking machine.

A similar smoking behaviour device of the company SODIM also requires the use of a smoking duplicator in a laboratory to reproduce the smoker's smoking behaviour in order to obtain smoke delivery measurements.

Previous smoking behaviour devices, such as those described by Roger Jenkins in 1990 have attempted to measure smoke concentration by light reflection whereby a light emitter and light detector have been located on the same side of a housing containing smoke. The density of the smoke has been determined by measuring the amount of light reflected by smoke particles back into the light detector. This ‘light scattering’ methodology has not given reliable results because only smoke density nearest the detector is measured, not the average density across the whole smoke path. The present invention represents a significant improvement over this methodology. Another disadvantage of the reflection method is that the brightness of the light emitter cannot be checked or set to a known level thus making calibration unreliable. The present invention makes it easy to set the brightness of the light emitter.

There is thus a need in the smoking behaviour analyser field to provide a device, advantageously a portable device, that not only measures puffing behaviour but also provides real-time measurement of at least one smoke component with improved accuracy and negates the need to use a smoking duplicator machine. It is an object of the invention to provide such a device.

It is also an object of the invention to provide real-time visual displays of various smoking behaviour measurements carried out by the device.

It is a further object to provide in addition a record of the smoking behaviour of a consumer.

The present invention provides a smoking behaviour analyser comprising:

smoking article mounting means, by which a smoking article can be mounted at a mouth end thereof, the mounting means comprising a mouthpiece which, when holding a smoking article, is in fluid-flow communication with the mouth end of the smoking article;

fluid flow pressure drop detection means and smoke density detection means;

signal conversion means operable to convert signals obtained from the fluid flow pressure drop detection means and smoke density detection means into data;

data processing means operable to process data, the data processing means comprising a processor operable to process a calculation of a delivery value of particulate phase smoke components from a smoking article when mounted by the mounting means and being smoked via the mouthpiece;

and display means operable to display processed data in graphical and/or numerical form.

It should be noted that this invention does not cover the embodiments described in our co-pending application, International Patent Application No. WO02/098245, namely the measurement, conversion and transmission of data at the mounting means, separate from processing thereof at a remote location, unless there is additionally processing of the converted data at the mounting means prior to transmission to display means, which is not contemplated in that co-pending application.

Preferably the fluid flow pressure drop detection means comprises two openings, in the mounting means one located at either side of an orifice plate. The openings are connected to pressure sensors, such as pressure transducers. Advantageously the pressure sensors are located in data acquisition means or data processing means. Alternatively the pressure sensors are located in the mounting means. Suitable pressure transducers are those such as SenSym SCX 01DM or the like.

Preferably the fluid flow pressure drop detection means is operable to take two pressure measurements; one being the difference in pressure between atmospheric pressure and that within the holder (the pressure drop through the smoking article) and the other being the pressure difference between either side of the orifice plate, this pressure difference being proportional to the flow through the orifice.

Preferably the smoke density detection means comprises a light emitter and a light receiver. Advantageously the light emitter is a device, such as an LED, which emits light at visible or other wavelengths, e.g. infra-red. Advantageously the light detector is a device, such as a photodiode, selected for optimum performance at the wavelength of the emitted light. Preferably the light emitter and light receiver are located opposite to one another, within the mounting means. The distance between the emitter and receiver is advantageously between 2-6 mm, and is usually about 4 mm.

Preferably the smoke analyser is portable. By ‘portable’ is meant that the analyser, whether by its individual parts or not, is carryable by hand.

Preferably in one aspect of the invention the signal conversion means is located distant the mounting means. The signal conversion means may suitably be located in unit with data processing means. Alternatively, signal conversion means is located separately from data processing means.

Data processing means may additionally comprise data acquisition means. Signal conversion means may be located in data acquisition means. Preferably data processing means and data display means are located in unit with one another.

In an alternative aspect of the invention, signal conversion and data processing occur in unit with the mounting means.

Storage means may also be provided in unit with the mounting means or alternatively be located separately therefrom.

The data processing means is preferably a computer, with a processor, the computer being loaded with a suitable program. The data processing means preferably communicates bi-directionally with the source of data, which may be either the mounting means, signal conversion means or the data acquisition device, and carries out the necessary calculations to determine the required smoking behaviour information and smoke deliveries. Preferably, for ease of portability, the data processing means is a laptop computer.

Preferably the data processing means also comprises the display means.

Advantageously the display means gives real-time information about each puff. Preferably the puff information includes one or more of puff volume, puff shape, puff duration, smoke concentration, smoke mass per unit time, optical density, mean pressure drop, effort and time period. Much by preference is the display of one or more of this data in graphical form individually for each puff taken by the smoker.

Preferably the puffing profile and associated data is retained by the processing means for further examination, if required.

Advantageously the processing means is programmed to reset before acquisition of data between every smoke and zeroes the fluid pressure drop detection means and smoke density detection means.

It is conceivable that the signals derived from the fluid-pressure drop detection means and smoke density detection means may be transferred to the data processing device in a conductorless fashion, for example, by electromagnetic wave means. However, the transfer can also be conveniently accomplished using electrical leads for the optical signals and flexible tubing for the pressure measurements.

In order that the subject invention may be clearly understood and readily carried into effect, reference will now be made, by way of example, to the accompanying drawings, in which:

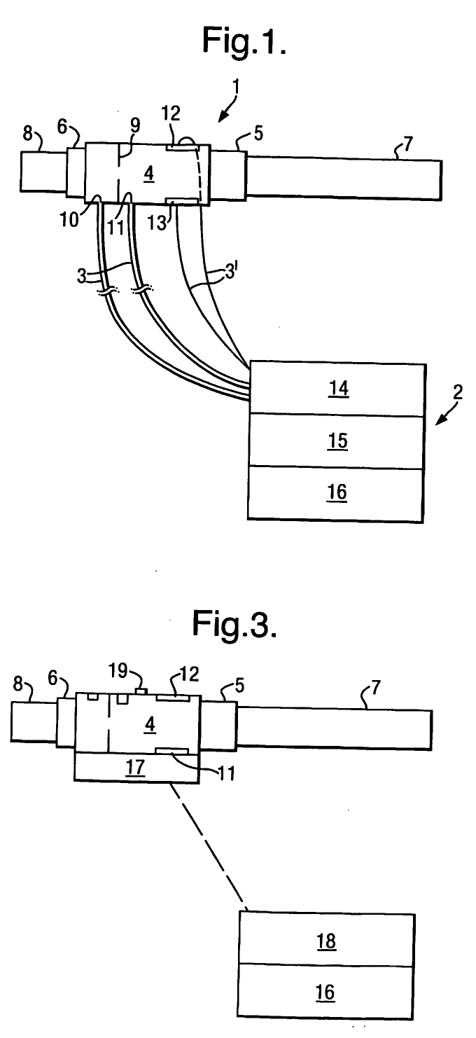

FIG. 1 shows a block diagram depiction of a smoking behaviour analyser,

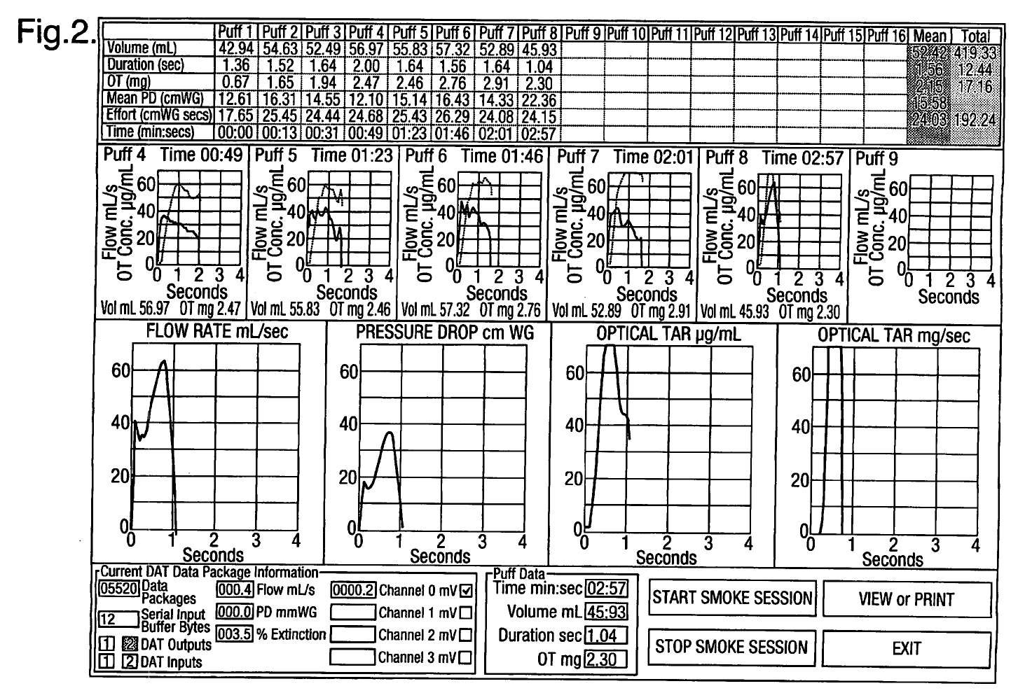

FIG. 2 shows a display screen of a smoking behaviour analyser in accordance with the invention, and

FIG. 3 shows a further embodiment of the invention.

The smoking behaviour analyser of FIG. 1 comprises a smoking article mounting assembly 1 and a data processing and display assembly 2. The data processing and display assembly 2 is connected to the smoking article assembly 2 by a pair of flexible tubes 3 and electrical leads 3′, each lead comprising two wires.

The cigarette mounting assembly 1 comprises a housing 4, at one end of which is secured a hollow sleeve 5 and at the opposite end of which is secured a mouthpiece holder 6. A cigarette (7) can be mounted in the sleeve 5 and a disposable mouthpiece (8) can be attached to the holder 6. With such a cigarette and such a mouthpiece, the mouthpiece is in fluid-flow communication with the cigarette via the hollow interior of the housing 4, such that the cigarette may be smoked via the mouthpiece.

Mounted within the housing 4 is fluid-flow pressure drop detection means comprising an orifice plate 9 and, one to each side of the orifice plate 9, are two openings 10 and 11 connected to pressure transducers. Also mounted within the housing 4 is smoke density detection means comprising a light emitter 12, in this instance a light emitting diode and, opposed to the transmitter, a light receiver 13, in this instance being a photodiode.

The data processing and display assembly 2 is operable to receive pressure measurements obtained from voltages given by pressure transducers located within data acquisition means 14, which transducers are connected to openings 10 and 11 by flexible tubes. The data acquisition means 14 also receives an electrical signal, such as a voltage, from the light receiver 13. In this instance, signal conversion occurs in the data acquisition means. The data acquisition means also transmits data derived from the conversion of these pressure measurements and light related signals to data processing means 15, in this embodiment a lap top computer.

Processing means 15 produces, or includes, a real time delivery of the particulate phase components of mainstream smoke (known as ‘tar’) from the cigarette which is mounted in the sleeve 5 of the housing 4 and is being smoked via a mouthpiece (8) mounted in the holder 6 of the housing 4.

The obnubilation effected by the mainstream smoke on the light emitted by the light emitter 12, which obnubilation is registered by way of the light receiver 13, provides a means of determining the instantaneous density values of the smoke, i.e. the concentration therein of the particulate phase components. This is referred to as the optical density of the smoke.

The determination of the density values by the processor is achieved by using a calibration curve obtained from the data of standard cigarettes with known smoke yields at certain concentrations.

Processed data, such as, for example, the real-time values of ‘tar’, can be displayed by display means 16, in this instance the display screen of the lap-top computer.

In use, the data acquisition means 14 reads the pressure and flow data obtained from the pressure transducers 10,11 and the light extinction (or optical density) between the light emitter 12 and the light receiver 13 over a particular time period, in this instance 25 times per second, and transmits these values to the processing means 15.

Processing means 15 takes the flow readings and converts them to puff volumes, puff shapes and durations for each puff taken. The processing means 15 also takes the light extinction readings and converts those readings to smoke concentrations. The processing means 15 then combines the smoke flow and smoke concentrations to calculate puff by puff deliveries of ‘tar’ and also the total ‘tar’ value for each cigarette smoked by the consumer

The smoking analyser of this invention is also able to display these calculated yields in graphical form for each puff or for a total puff number. In addition, any of the puff volume, puff shape (flow versus time), puff duration, optical density, mean pressure drop, effort and time period can be represented numerically or graphically on the display (see, for example, FIG. 2). The user is thus provided with a visual record of a consumer's real-time puffing behaviour and/or delivery profile. The smoker's profile is also retained by the processing means.

In another embodiment (not shown), the display means may be separate from the data processing means.

In a second aspect of the invention shown in FIG. 3 there is a smoking article mounting assembly 1. The mounting assembly comprises all the features associated with the mounting assembly described in FIG. 1 within the housing 4. However, in addition, located in unit (and adjacent with) the housing 4 is signal conversion means and data processing means 17. Data processing means 17 is operable to calculate the particulate smoke delivery.

Advantageously the mounting assembly 1 is in connection with data storage means 18, the storage means being located distant from the mounting assembly. Preferably data storage means comprises input means to allow a user to input smoker details to each smoker record. Data storage and input means in the first embodiment may be provided by the processor and keyboard of the computer. Data storage is also advantageously provided in the first embodiment.

The mounting means assembly is provided with means 19, such as a button, to reset the processing means 17 after each smoking event.

Furthermore, the signals obtained from the fluid pressure drop detection means and smoke density detection means may, if desired, be transferred to the data acquisition device in a conductorless (or wire-less) fashion.

Particular advantages of this invention include the ability to provide a particulate smoke yield of a cigarette extremely quickly, without the need for chemical analysis, using a smoking machine. In addition, it is often desirable to obtain a puff by puff yield of a smoking article, as this is of interest to product developers, for example.

The present invention can also be connected to a smoking machine and used to measure the puff volume, puff duration and puff profile, thereby ensuring correct performance and consistency of measurement.

The invention can also be used to provide a real-time estimate of total and puff-by-puff yields of a smoke component from smoking articles when smoked on a smoking machine.

1. A smoking behaviour analyser comprising:
smoking article mounting means, by which a smoking article can be mounted at a mouth end thereof, the mounting means comprising a mouthpiece which, when holding a smoking article, is in fluid-flow communication with the mouth end of the smoking article;
fluid flow pressure drop detection means and smoke density detection means;
signal conversion means operable to convert signals obtained from the fluid flow pressure drop detection means and smoke density detection means into data;
data processing means operable to process data, the data processing means comprising a processor operable to process a calculation of a delivery value of particulate phase smoke components from a smoking article when mounted by the mounting means and being smoked via the mouthpiece;
and display means operable to display processed data in graphical and/or numerical form.

2. A smoking behaviour analyzer according to claim 1, wherein said fluid flow pressure drop detection means comprises two openings in the mounting means, one opening each being located at either side of an orifice plate, and the openings being connected to pressure sensors.

3. A smoking behaviour analyser according to claim 2, wherein said pressure sensors are pressure transducers.

4. A smoking behaviour analyser according to claim 2, wherein said pressure sensors are located in data acquisition means or data processing means.

5. A smoking behaviour analyser according to claim 2, wherein said pressure sensors are located in the mounting means.

6. A smoking behaviour analyser according to claim 1, wherein said pressure transducers are SenSym SCX 01DM or the like.

7. A smoking behaviour analyser according to claim 1, wherein said fluid flow pressure drop detection means is operable to take two pressure measurements; one being the difference in pressure between atmospheric pressure and that within the holder, and the other being the pressure difference between either side of the orifice plate, this pressure difference being proportional to the flow through the orifice.

8. A smoking behaviour analyser according to claim 1, wherein said smoke density detection means comprises a light emitter and a light receiver.

9. A smoking behaviour analyser according to claim 8, wherein said light emitter is a device which emits light at visible or other wavelengths.

10. A smoking behaviour analyser according to claim 9, wherein said light emitter is a light emitting diode (LED).

11. A smoking behaviour analyser according to claim 9, wherein said light detector is a device selected for optimum performance at the wavelength of the emitted light.

12. A smoking behaviour analyser according to claim 11, wherein said light detector is a photodiode.

13. A smoking behaviour analyser according to claim 8, wherein said light emitter and said light receiver are located opposite to one another within the mounting means.

14. A smoking behaviour analyser according to claim 13, wherein the distance between said emitter and said receiver is between 2-6 mm.

15. A smoking behaviour analyser according to claim 14, wherein the distance is about 4 mm.

16. A smoking behaviour analyser according to claim 1, wherein said smoke analyser is portable.

17. A smoking behaviour analyser according to claim 1, wherein said signal conversion means is located distant the mounting means.

18. A smoking behaviour analyser according to claim 17, wherein said signal conversion means is located in unit with data processing means.

19. A smoking behaviour analyser according to claim 1, wherein said signal conversion means is located separately from data processing means.

20. A smoking behaviour analyser according to claim 1, wherein said data processing means additionally comprises data acquisition means.

21. A smoking behaviour analyser according to claim 20, wherein said signal conversion means is located in said data acquisition means.

22. A smoking behaviour analyser according to claim 1, wherein said data processing means and said data display means are located in unit with one another.

23. A smoking behaviour analyser according to claim 1, wherein signal conversion and data processing occur in unit with the mounting means.

24. A smoking behaviour analyser according to claim 1, wherein storage means is provided in unit with the mounting means or alternatively located separately therefrom.

25. A smoking behaviour analyser according to claim 1, wherein said data processing means is a computer, with a processor, the computer being loaded with a suitable program.

26. A smoking behaviour analyser according to claim 1, wherein said data processing means communicates bi-directionally with the source of data, which may be either the mounting means, signal conversion means or the data acquisition device, and carries out the necessary calculations to determine the required smoking behaviour information and smoke deliveries.

27. A smoking behaviour analyser according to claim 25, wherein said data processing means is a laptop computer.

28. A smoking behaviour analyser according to claim 25, wherein said data processing means also comprises said display means.

29. A smoking behaviour analyser according to claim 1, wherein said display means displays real-time information about each puff.

30. A smoking behaviour analyser according to claim 29, wherein the puff information displayed includes one or more of puff volume, puff shape, puff duration, smoke concentration, smoke mass per unit time, optical density, mean pressure drop, effort and time period.

31. A smoking behaviour analyser according to claim 1, wherein the display of one or more of this data is in graphical form individually for each puff taken by the smoker.

32. A smoking behaviour analyser according to claim 1, wherein the puffing profile and associated data is retained by the processing means for further examination.

33. A smoking behaviour analyser according to claim 1, wherein said processing means is programmed to reset before acquisition of data between every smoke and zeroes the fluid pressure drop detection means and smoke density detection means.

34. A smoking behaviour analyser according to claim 1, wherein the signals derived from the fluid-pressure drop detection means and smoke density detection means are transferred to the data processing device in a conductorless fashion.

35. A smoking behaviour analyser according to claim 34, wherein signal transfer is by electromagnetic wave means.

36. A smoking behaviour analyser according to claim 1, wherein the signals derived from the fluid-pressure drop detection means and smoke density detection means are transferred to the data processing device transfer by using electrical leads for the optical signals and flexible tubing for the pressure measurements.

37. (canceled)

38. A smoking behaviour analyser according to claim 1, wherein measurement, conversion and transmission of data at the mounting means, separate from processing thereof at a remote location does not occur, unless there is additionally processing of the converted data at the mounting means prior to transmission to display means.
